(19) United States
(12) Patent Application Publication
(10) Pub. No.: US 2010/0285193 A1
(43) Pub. Date: Nov. 11, 2010

(54) METHOD OF TREATING LIQUID FOOD

(75) Inventors: Yoshinori Satake, Kanagawa (JP); Ikuru Toyoda, Kanagawa (JP)

Correspondence Address: BUCHANAN, INGERSOLL & ROONEY PC, POST OFFICE BOX 1404, ALEXANDRIA, VA, 22313-1404, US

(73) Assignee: Meiji Dairies Corporation, Koutou-ku (JP)

(21) Appl. No.: 12/682,661

(22) PCT Filed: Dec. 26, 2008
(86) PCT No.: PCT/JP2008/073804

§ 371 Date: Jul. 13, 2010

(30) Foreign Application Priority Data
Jan. 21, 2008 (JP) 2008-010147

(51) Int. Cl. A23C 9/16

(52) U.S. Cl. 426/471; 426/487

(57) ABSTRACT

The present invention suggests a method for treating a liquid food, which is suitable for efficiently and effectively decreasing the dissolved oxygen concentration in liquid foods having high foaming property and low defoaming property such as skim milk. The dissolved oxygen concentration of the liquid food is decreased by putting the liquid food into a decompression vessel while heating the liquid food to a temperature higher than or equal to the saturation temperature (boiling point) of the liquid food under the decompression atmosphere in the decompression vessel, or putting the liquid food into a decompression vessel while depressurizing the decompression vessel to a pressure lower than or equal to the saturation vapor pressure of the liquid food at the temperature of the liquid food.

### TECHNICAL FIELD

The present invention relates to a method for treating a liquid food, specifically to a method for treating a liquid food suitable for efficiently and effectively decreasing dissolved oxygen concentration in liquid foods having high foaming property and low defoaming property.

### BACKGROUND ART

Various suggestions have been made long before for treatments aiming at decreasing dissolved oxygen concentration in liquid foods.

For example, a batchwise method for efficiently removing dissolved oxygen by supplying water to a decompression vessel and boiling the water by heating (Japanese Patent Application Laid-Open (JP-A) No. 7-47351) and a continuous method for efficiently removing the dissolved oxygen by supplying water to a decompression vessel and boiling the water by heating (JP-A No. 9-299709) have been suggested.

Furthermore, a method for decreasing dissolved oxygen by spraying a beverage into a decompression vessel while keeping the temperature of the beverage lower than or equal to its boiling point so as to increase the surface area of the beverage (JP-A No. 2005-304390) and a method for decreasing dissolved oxygen by incorporating inert gas into a beverage and eliminating air bubbles under a depressurized atmosphere (JP-A No. 2005-110527) have been suggested.

### DISCLOSURE OF THE INVENTION

The above-mentioned treatment methods described in JP-A Nos. 7-47351 and 9-299709 are applied to water, but not applied to the treatment of liquid foods having high foaming property and low defoaming property.

Where a treatment aiming at decreasing dissolved oxygen is performed on liquid foods having high foaming property and low defoaming property such as skim milk, it is difficult to effectively decrease dissolved oxygen concentration using a method by heating in a decompression vessel as suggested by JP-A Nos. 7-47351 and 9-299709, due to generation of air bubbles.

Furthermore, the method of JP-A No. 2005-304390 requires many nozzles for spraying a beverage and has a limitation in treatment performance and problems in washing property, maintenance property, costs, and the like, and the method of JP-A No. 2005-110527 requires large equipments such as a vessel for incorporating inert gas and a decompression vessel and has problems in costs and the like.

Liquid foods having high foaming property and low defoaming property include skim milk and the like. Where the dissolved oxygen concentration of skim milk is decreased by incorporating (bubbling) inert gas (nitrogen or the like) into skim milk, the skim milk excessively bubbles and the air bubbles still remain after the skim milk is retained for a predetermined time. At this time, the air bubbles are not diminished, and incorporated in the liquid (skim milk), which leads to failures that the flow amount does not become constant where the liquid is delivered by a pump or the like, and the like.

Where the above-mentioned liquid that has not been defoamed is heated in a heat exchanger (a sterilizer) or the like, the heat transfer efficiency is decreased, and failures such as burning of the heating surface occur. Furthermore, where a liquid that has not been defoamed is subjected to membrane separation treatment using a crossflow filtration machine or the like, the operation pressure is varied, and failures that the permeate flux becomes unstable, and the like occur.

Meanwhile, where the dissolved oxygen concentration was decreased in liquid foods having high foaming property and low defoaming property such as skim milk, decrease of the dissolved oxygen concentration was not sufficient after the liquid food was simply retained under a depressurized (vacuum) atmosphere or formed into liquid drops or liquid membrane and then put into a depressurized atmosphere.

Accordingly, liquid foods having high foaming property and low defoaming property such as skim milk had a problem that combination use of incorporation (bubbling) of inert gas and a depressurized (vacuum) atmosphere, and the like are necessary when the liquid food is retained under the depressurized (vacuum) atmosphere or formed into liquid drops or liquid membrane and then put into the depressurized atmosphere in order to decrease the dissolved oxygen concentration, which makes the equipments and steps complex and increases the equipment investment and the costs for the treatment.

Accordingly, the present invention aims at suggesting a method for treating a liquid food, which is suitable for efficiently and effectively decreasing the dissolved oxygen concentration in liquid foods having high foaming property and low defoaming property such as skim milk.

The invention according to a first aspect of the present invention is a method for treating a liquid food, which decreases the dissolved oxygen concentration of the liquid food by putting the liquid food into a decompression vessel while heating the liquid food to a temperature higher than or equal to the saturation temperature of the liquid food under the decompression atmosphere in the decompression vessel.

The invention according to a second aspect is a method for treating a liquid food, which decreases the dissolved oxygen concentration of the liquid food by putting the liquid food into a decompression vessel while depressurizing the decompression vessel to a pressure lower than or equal to the saturation vapor pressure of the liquid food at the temperature of the liquid food.

The invention according to a third aspect is the method for treating a liquid food according to the first or second aspect, which decreases the dissolved oxygen concentration of the liquid food by subsequently putting the liquid food in which the dissolved oxygen concentration has been decreased in the decompression vessel into an inert gas atmosphere at normal pressure.

The invention according to a forth aspect is the method for treating a liquid food according to any one of the first to third aspects, wherein the liquid food is skim milk.

The invention according to a fifth aspect is a method for preparing a powdered food, which comprises powderizing a liquid food in which the dissolved oxygen concentration has been decreased by the method for treating a liquid food according to any one of the first to third aspects.

The invention according to a sixth aspect is the method for preparing a powdered food according to the fifth aspect, wherein the liquid food is skim milk.

The invention according to a seventh aspect is a method for preparing powdered skim milk, which comprises centrifuging raw milk at from 40 to 60° C. to give skim milk and subjecting the skim milk to sterilization, concentration and spray drying to give the powdered skim milk, wherein the powdered skim milk is prepared by centrifuging raw milk at from 40 to 60° C. to give skim milk, decreasing the dissolved oxygen concentration of the skim milk by continuously using the method for treating a liquid food according to any one of the first to third aspects, and subsequently subjecting the skim milk to the steps of sterilization, concentration and spray drying.

The present invention can provide a method for treating a liquid food, which is suitable for efficiently and effectively decreasing the dissolved oxygen concentration in liquid foods having high foaming property and low defoaming property such as skim milk.

### BEST MODE FOR CARRYING OUT THE INVENTION

In the method for treating a liquid food suggested by the present invention, the dissolved oxygen concentration of the liquid food is decreased by putting the liquid food into a decompression vessel (a depressurize tank, a vacuum vessel, a vacuum tank or the like) while heating the liquid food to a temperature higher than or equal to the saturation temperature (boiling point) of the liquid food under a decompression atmosphere in the decompression vessel or putting the liquid food into the decompression vessel while depressurizing a decompression vessel to a pressure lower than or equal to the saturation vapor pressure (saturation pressure) of the liquid food at the temperature of the liquid food.

According to such treatment method of the present invention, air bubbles are not generated, unlike the conventional methods in which inert gas is incorporated into a liquid food. Therefore, the treatment method is suitable for efficiently and effectively decreasing the dissolved oxygen concentration in liquid foods having high foaming property and low defoaming property such as skim milk. Furthermore, the treatment method of the present invention can innovatively decrease the dissolved oxygen concentration, unlike the conventional methods comprising degassing by depressurization under low temperature or ordinary temperature.

In the treatment method of the present invention, where the liquid food is put into the decompression vessel, the liquid food may be formed into liquid drops or liquid membrane to increase the surface area and then put into a depressurized atmosphere, the liquid food may be simply put into a depressurized atmosphere in the form of a liquid column as it is from piping (pipes) or the like, or the liquid food may be retained as it is under a depressurized atmosphere for a short time period. During this operation, unlike the conventional treatment methods, a sufficient effect of the present invention can be obtained by simply putting the liquid food in the form of a liquid column as it is into the depressurized atmosphere from the piping or the like. Therefore, the method by simply putting the liquid food in the form of a liquid column as it is into the depressurized atmosphere from the piping or the like is preferable in view of washing property, maintenance property, costs and the like.

According to the experiment made by the present inventors, the above-mentioned treatment method of the present invention could decrease the dissolved oxygen concentration to 2 ppm or less in the liquid food having the dissolved oxygen concentration of 13 ppm.

In the treatment method of the present invention, the liquid food is put into a decompression vessel while heating the liquid food to a temperature higher than or equal to the saturation temperature (boiling point) of the liquid food under the decompression atmosphere in the decompression vessel. Alternatively, the liquid food is put into a decompression vessel while depressurizing the decompression vessel to a pressure lower than or equal to the saturation vapor pressure of the liquid food at the temperature of the liquid food. Therefore, the dissolved oxygen concentration is decreased (degassed) while evaporating a part of the water in the liquid food. During this operation, the amount of the evaporated water is small, unlike a method in which latent heat is continuously provided with the liquid food such as conventionally-used evaporation concentration.

The treatment temperature and treatment pressure (decompression vessel) used in the present invention may be suitably determined according to the effect on the physical properties and quality of the liquid food, the effect on the control of the degree of vacuum (degree of depressurization) in the decompression vessel, and the like. For example, where the temperature of the liquid food is too high, denaturation of proteins, deterioration of flavor, and the like may be concerned, and where the pressure in the decompression vessel is too low, specific strength, specific depressurizing equipments and control, and the like may be necessitated for the decompression vessel.

From these viewpoints, the specific temperature for the treatment of the present invention is preferably from 20 to 90° C., more preferably from 30 to 80° C., further preferably from 30 to 75° C., and specifically preferably from 35 to 75° C., and the treatment temperature is from 0.5 to 30° C., preferably from 0.5 to 20° C., more preferably from 1 to 15° C., and further preferably from 1 to 10° C. higher than the saturation temperature.

The pressure for the treatment of the present invention is preferably from 1 to 50 kPa, more preferably from 3 to 40 kPa, further preferably from 5 to 30 kPa, and specifically preferably 5 to 25 kPa, and the treatment pressure is from 0.5 to 25 kPa, preferably from 0.5 to 20 kPa, more preferably from 1 to 15 kPa, and further preferably from 1 to 10 kPa lower than the saturation vapor pressure.

In the present invention, the liquid food in which the dissolved oxygen concentration has been decreased in the decompression vessel as mentioned above is subsequently put into an inert gas atmosphere (an inert gas filling vessel, an inert gas filling tank, a nitrogen vessel, a nitrogen filling tank, or the like) at normal pressure, whereby the dissolved oxygen concentration of the liquid food may further be decreased.

According to the experiment made by the present inventors, the liquid food in which the dissolved oxygen concentration could be decreased from 13 ppm to 2 ppm by the treatment method of the present invention as mentioned above was then put into an inert gas atmosphere at normal pressure, whereby the dissolved oxygen concentration could be decreased to 1.5 ppm or less.

It is preferable that nitrogen is used as the inert gas atmosphere for the present invention in view of costs and the like, and that the inert gas atmosphere is realized in a predetermined vessel in which a predetermined amount of nitrogen is supplied to the gas phase in the vessel (a nitrogen vessel). Furthermore, the inert gas atmosphere used in the present invention may be suitably designed taking into account the effect on the physical properties and quality of the liquid food, the effect of the inert gas filling tank (nitrogen vessel) on the control of the amount of the supplied inert gas (nitrogen), and the like. For example, where the amount of the supplied nitrogen in the nitrogen vessel is too small, the dissolved oxygen concentration cannot be sufficiently decreased, and where the amount of the supplied nitrogen in the nitrogen vessel is too much, increase in the costs for purchasing nitrogen, hazard to human bodies (workers), and the like may be concerned, and a specific exhaust equipment and control and the like may be necessitated.

From the above-mentioned viewpoints, the specific amount of nitrogen to be supplied in the present invention is preferably from 1 to 2-fold, more preferably from 1.2 to 1.8-fold, further preferably from 1.3 to 1.8-fold, and specifically preferably from 1.4 to 1.5-fold, with respect to the flow of the supplied liquid (treatment liquid).

In the present invention, the liquid food may include fruit juice beverages, coffee beverages, black tea beverages, green tea beverages, milk beverages, processed milk, quality governing milk, raw milk (whole milk), cream and the like, preferably skim milk. By applying the treatment method of the present invention to a liquid food having high foaming property and low defoaming property such as skim milk, the dissolved oxygen concentration can be decreased efficiently and effectively.

Furthermore, a powdered food can be prepared by powderizing the liquid food in which the dissolved oxygen concentration has been decreased by the method for treating a liquid food according to the present invention.

Although various powderization methods conventionally used in this technical field such as spray drying can be adopted to the above-mentioned powderization treatment, by powderizing the liquid food in which the dissolved oxygen concentration has been decreased by the method for treating a liquid food according to the present invention, the quality of the powdered food prepared can be improved and enhanced by powderizing the liquid food in which the dissolved oxygen concentration has been decreased by the method for treating a liquid food according to the present invention.

For example, powdered skim milk, which is a powdered food prepared by powderizing the skim milk in which the dissolved oxygen concentration has been decreased by the method for treating a liquid food according to the present invention wherein the liquid food is skim milk, has a more excellent quality than that of powdered skim milk to which the method for treating a liquid food according to the present invention is not applied.

Accordingly, by incorporating the method for treating a liquid food according to the present invention into a conventional step for the preparation of powdered skim milk, powdered skim milk having an improved quality can be prepared continuously.

For example, a method for preparing powdered skim milk, which comprises centrifuging raw milk at from 40 to 60° C. to give skim milk, and subjecting the skim milk to sterilization, concentration and spray drying to give powdered skim milk, wherein the powdered skim milk is prepared by centrifuging raw milk at from 40 to 60° C. to give skim milk, decreasing the dissolved oxygen concentration in the skim milk by continuously using the method for treating a liquid food of the present invention, and subsequently subjecting the skim milk to the steps of sterilization, concentration and spray drying, may be exemplified. In this method, a flash cooler or the like can be used as the decompression vessel. The temperature for centrifuging raw milk is preferably from 45 to 55° C., and more preferably from 50 to 55° C.

In this case, the skim milk obtained by centrifuging raw milk is heated in advance. Therefore, the heat efficiency is specifically good since the dissolved oxygen concentration of the skim milk can be decreased by directly using the method for treating a liquid food according to the present invention, without additional heating by using a heat exchanger or the like.

Furthermore, as mentioned above, where the method for treating a liquid food according to the present invention in which the skim milk in which the dissolved oxygen concentration has been decreased in the decompression vessel is subsequently put into an inert gas atmosphere at normal pressure so as to further decrease the dissolved oxygen concentration of the liquid food, is performed, and the steps for sterilization, concentration and spray drying are subsequently performed, the inert gas-filled tank (normal pressure) that is used in the step for putting the skim milk in which the dissolved oxygen concentration has been decreased in the decompression vessel into the inert gas atmosphere at normal pressure may be used as a buffer tank that is provided prior to the sterilization step.

Hereinafter the preferable examples of the present invention are explained. However, the present invention is not limited to the above-mentioned preferable embodiments and the following examples, and may be modified to various forms within the technical scope that is recognized from the description of the claims.

### Example 1

The method for treating a liquid food according to the present invention is explained with referring to FIGS. 1 and 2. FIG. 1 shows a schematic drawing for explaining an example of the system in which the method for treating a liquid food according to the present invention is performed, and FIGS. 2(a) and 2(b) show flow charts for explaining the overview steps of the method for treating a liquid food according to the present invention.

As shown in the overview steps in FIG. 2(a), treatment liquid 1 contained in treatment tank 2 is heated to a predetermined temperature in heat exchanger (for heating) 3, and put into depressurize tank 4 and degassed therein by depressurization, whereby the dissolved oxygen concentration in the treatment liquid 1 can be decreased.

As the method for degassing by depressurization, a method comprising putting the treatment liquid 1 into the depressurize tank 4 while heating the treatment liquid 1 by the heat exchanger 3 to a temperature higher than or equal to the saturation temperature (boiling point) of the treatment liquid 1 under the decompression atmosphere in the depressurize tank 4, can be adopted.

Alternatively, a method comprising putting the treatment liquid 1 into the depressurize tank 4 while depressurizing the depressurize tank 4 to a pressure lower than or equal to the saturation vapor pressure of the treatment liquid 1 at the temperature of the liquid to be treated 1 being heated by the heat exchanger 3, can also be adopted.

In the treatment method of the present invention shown by the overview steps in FIG. 2(b), the treatment liquid 1 in which the dissolved oxygen concentration has been decreased in the depressurize tank 4 is subsequently put into an inert gas atmosphere at normal pressure, whereby the dissolved oxygen concentration in the treatment liquid 1 is further decreased.

As the method for putting the treatment liquid 1 into an inert gas atmosphere at normal pressure, a method comprising putting the treatment liquid 1 that is delivered from the depressurize tank 4, into inert gas-filled tank 5 in which inert gas (nitrogen gas in the embodiment illustrated in FIG. 1) is filled and which is open to ordinary pressure, can be adopted.

### Experimental Example 1

As the treatment liquid 1, reconstituted skim milk (dissolved oxygen concentration: 13 ppm) was prepared in the treatment tank 2 instead of skim milk that is a liquid food having high foaming property and low defoaming property, and the dissolved oxygen concentration in the treatment liquid 1 was measured after the treatment by adjusting the flow of the treatment liquid 1 supplied to the depressurize tank 4, the temperature of the treatment liquid 1 (supplied liquid temperature) and the pressure in the depressurize tank 4 (vacuum vessel pressure), as shown in Tables 1 and 2. The results are shown in Tables 1 and 2, and FIGS. 5 and 6.

TABLE 1
Tests for decreasing dissolved oxygen by depressurization treatment (1) (Reconstituted skim milk, dissolved oxygen ≧13 ppm)

| Flow of | | | | | | | Treatment | |
|---|---|---|---|---|---|---|---|---|
| supplied | Pressure in | Supplied liquid | Saturation | Saturation | Amount of supplied | Dissolved oxygen | liquid | |
| liquid | depressurize | temperature | pressure | temperature | nitrogen in nitrogen | in treatment | temperature | |
| [L/h] | vessel [kPa] | [° C.] | [kPa] | [° C.] | vessel [L/h] | liquid [ppm] | [° C.] | Remarks |
| 205-210 | 8.0 | 70.0 | 31.2 | 43.0 | 0 | 0.71 | 34.3 | Nitrogen vessel: not used |
| 205-210 | 8.0 | 62.1 | 21.8 | 43.0 | 0 | 1.02 | 33.3 | Nitrogen vessel: not used |
| 205-210 | 8.0 | 54.5 | 15.3 | 43.0 | 0 | 1.20 | 31.2 | Nitrogen vessel: not used |
| 205-210 | 8.0 | 49.5 | 12.0 | 43.0 | 0 | 1.32 | 30.3 | Nitrogen vessel: not used |
| 205-210 | 8.0 | 43.5 | 8.9 | 43.0 | 0 | 1.91 | 30.2 | Nitrogen vessel: not used |
| 205-210 | 8.0 | 34.6 | 5.5 | 43.0 | 0 | 6.51 | 30.5 | Nitrogen vessel: not used |
| 205-210 | 8.0 | 26.1 | 3.4 | 43.0 | 0 | 6.70 | 23.7 | Nitrogen vessel: not used |
| 205-210 | 8.0 | 70.0 | 31.2 | 43.0 | 300 | 0.63 | 34.2 | Nitrogen vessel: used |
| 205-210 | 8.0 | 62.4 | 21.8 | 43.0 | 300 | 0.95 | 34.2 | Nitrogen vessel: used |
| 205-210 | 8.0 | 54.3 | 15.3 | 43.0 | 300 | 0.96 | 31.3 | Nitrogen vessel: used |
| 205-210 | 8.0 | 49.0 | 11.7 | 43.0 | 306 | 1.36 | 30.4 | Nitrogen vessel: used |
| 205-210 | 8.0 | 44.5 | 9.3 | 43.0 | 300 | 1.42 | 30.3 | Nitrogen vessel: used |
| 205-210 | 8.0 | 35.1 | 5.6 | 43.0 | 300 | 5.59 | 28.5 | Nitrogen vessel: used |
| 205-210 | 8.0 | 23.0 | 2.8 | 43.0 | 300 | 5.68 | 23.5 | Nitrogen vessel: used |

TABLE 2
Tests for decreasing dissolved oxygen by depressurization treatment (2) (Reconstituted skim milk, dissolved oxygen ≧13 ppm)

| Flow of | | | | | | | Treatment | |
|---|---|---|---|---|---|---|---|---|
| supplied | Pressure in | Supplied liquid | Saturation | Saturation | Amount of supplied | Dissolved oxygen | liquid | |
| liquid | depressurize | temperature | pressure | temperature | nitrogen in nitrogen | in treatment | temperature | |
| [L/h] | vessel [kPa] | [° C.] | [kPa] | [° C.] | vessel [L/h] | liquid [ppm] | [° C.] | Remarks |
| 205-210 | 18.7 | 74.3 | 37.6 | 59.8 | 0 | 0.54 | 48.0 | Nitrogen vessel: not used |
| 205-210 | 18.7 | 63.9 | 23.9 | 59.8 | 0 | 0.59 | 47.4 | Nitrogen vessel: not used |
| 205-210 | 18.7 | 53.5 | 14.7 | 59.8 | 0 | 6.20 | 45.5 | Nitrogen vessel: not used |
| 205-210 | 18.7 | 46.1 | 10.1 | 59.8 | 0 | 6.65 | 40.1 | Nitrogen vessel: not used |
| 205-210 | 18.7 | 74.5 | 37.6 | 59.8 | 312 | 0.31 | 46.7 | Nitrogen vessel: used |
| 205-210 | 18.7 | 64.2 | 23.9 | 59.8 | 306 | 0.45 | 46.4 | Nitrogen vessel: used |
| 205-210 | 18.7 | 53.5 | 14.7 | 59.8 | 306 | 5.02 | 44.0 | Nitrogen vessel: used |
| 205-210 | 18.7 | 45.3 | 9.8 | 59.8 | 306 | 5.83 | 37.2 | Nitrogen vessel: used |
| 205-210 | 21.3 | 74.2 | 37.6 | 62.5 | 0 | 0.46 | 50.1 | Nitrogen vessel: not used |
| 205-210 | 21.3 | 64.6 | 24.5 | 62.5 | 0 | 0.69 | 51.4 | Nitrogen vessel: not used |
| 205-210 | 21.3 | 53.6 | 14.7 | 62.5 | 0 | 6.18 | 44.9 | Nitrogen vessel: not used |
| 205-210 | 21.3 | 74.9 | 38.5 | 62.5 | 306 | 0.33 | 49.8 | Nitrogen vessel: used |
| 205-210 | 21.3 | 64.5 | 24.5 | 62.5 | 306 | 0.57 | 49.3 | Nitrogen vessel: used |
| 205-210 | 21.3 | 53.5 | 14.7 | 62.5 | 306 | 5.80 | 44.4 | Nitrogen vessel: used |

In Tables 1 and 2, the “nitrogen vessel: not used” refers to a treatment method whose overview steps are shown in FIG. 2(a), in which putting the treatment liquid 1 into the inert gas atmosphere at normal pressure using the inert gas-filled tank 5 illustrated in FIG. 1 was not performed. On the other hand, the “nitrogen vessel: used” in Tables 1 and 2 refers to a treatment method whose overview steps are shown in FIG. 2(b), in which putting the treatment liquid 1 into the inert gas atmosphere at normal pressure using the inert gas-filled tank 5 illustrated in FIG. 1 was performed.

Where the treatment liquid 1 was put into the depressurize tank 4 while heating the treatment liquid 1 to a temperature higher than or equal to the boiling point (saturation temperature) of the treatment liquid 1 under the decompression atmosphere in the depressurize tank 4, or put the treatment liquid 1 into the depressurize tank 4 while depressurizing the depressurize tank 4 to a pressure lower than or equal to the saturation vapor pressure of the treatment liquid 1 at the temperature of the liquid to be treated 1 being heated by the heat exchanger 3, the dissolved oxygen concentration could be extremely efficiently decreased without performing the treatment using the inert gas-filled tank 5.

Furthermore, it could be confirmed that the dissolved oxygen concentration can be further decreased by subsequently putting the treatment liquid 1 into an inert gas atmosphere at normal pressure using the inert gas-filled tank 5.

### Example 2

The method for preparing a powdered food using the method for treating a liquid food according to the present invention is explained with referring to FIG. 3. FIG. 3 shows flow charts for explaining the overview steps for preparing the powdered food using the method for treating a liquid food according to the present invention.

The methods for preparing the powdered food illustrated in FIGS. 3(a) and (b) each shows the preparation of the powdered food by preparing the liquid food (treatment liquid 1) in which the dissolved oxygen concentration has been decreased according to the treatment method of the present invention that is explained with referring to FIGS. 2(a) and (b), and powderizing the liquid food by adopting various powderization methods that are conventionally used in this technical field such as spray drying.

The powdered food treated as above has more excellent quality than that of the powdered food in which the treatment for decreasing dissolved oxygen concentration has not been performed.

For example, powdered skim milk, which is a powdered food prepared by powderizing the skim milk in which the dissolved oxygen concentration has been decreased by the method of the present invention illustrated in FIGS. 3(a) and (b) wherein the treatment liquid 1 is skim milk, has more excellent quality than that of the powdered skim milk in which the dissolved oxygen concentration of the skim milk has not been decreased.

### Example 3

The method for preparing a powdered skim milk using the method for treating a liquid food according to the present invention is explained with referring to FIGS. 4(a) and 4(b). FIGS. 4(a) and (b) show flow charts for explaining the overview steps for preparing powdered skim milk using the method for treating a liquid food according to the present invention.

The methods for preparing powdered skim milk illustrated in FIGS. 4(a) and (b) each shows the preparation of the powdered milk by preparing skim milk in which the dissolved oxygen concentration has been decreased according to the treatment method of the present invention explained by using FIGS. 2(a) and (b), and then subjecting the skim milk to sterilization, concentration and spray drying in a conventional manner.

Raw milk is centrifuged at from 40 to 60° C. to be separated into skim milk and cream. The thus-obtained skim milk at from 40 to 60° C. is directly and continuously put into the depressurize tank 4 illustrated in FIG. 1, and the skim milk is degassed therein by depressurization, whereby the dissolved oxygen concentration in the skim milk is decreased (FIG. 4(a)).

Furthermore, the skim milk in which the dissolved oxygen concentration has been decreased in the depressurize tank 4 is subsequently put into the inert gas-filled tank 5 in which inert gas (nitrogen gas in the embodiment illustrated in FIG. 1) is filled and which is open to ordinary pressure, whereby the dissolved oxygen concentration is further decreased (FIG. 4(b)).

The powdered skim milk can be obtained by subjecting the skim milk in which the dissolved oxygen concentration has been decreased to sterilization, concentration and spray drying in a conventional manner.

For the reconstituted skim milk in Experimental Example 1, the dissolved oxygen concentration can also be effectively decreased at the temperature range (from 40 to 60° C.) in which the raw milk is separated into skim milk and cream by centrifugation.

Therefore, it is possible to separate the raw milk into skim milk and cream by centrifugation, and then directly and immediately put the separated skim milk into the depressurize tank 4 to decrease the dissolved oxygen concentration.

Furthermore, where the dissolved oxygen concentration of the skim milk in which the dissolved oxygen concentration has been decreased is further decreased by subsequently putting the skim milk into an inert gas atmosphere at normal pressure as illustrated in FIG. 4(b), the inert gas-filled tank 5 can be used as a buffer tank that is provided prior to the subsequent steps for sterilization, concentration and spray drying.

### BRIEF DESCRIPTION OF THE DRAWINGS

FIG. 1 shows a schematic drawing for explaining one example of the system in which the method for treating a liquid food according to the present invention is carried out.

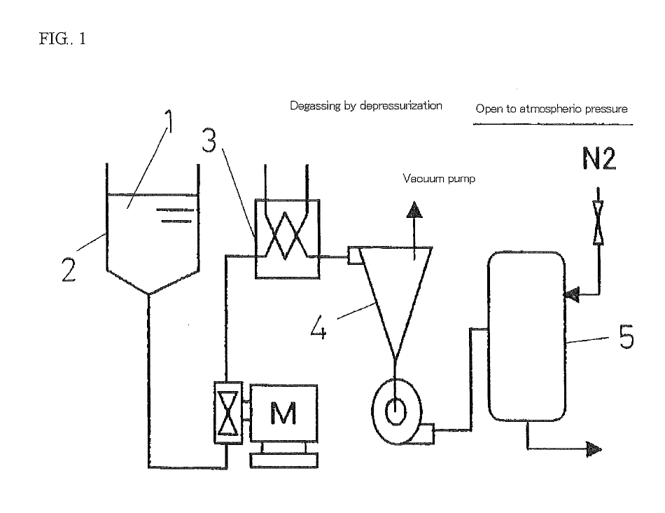

FIGS. 2(a) and (b) show flow charts for explaining the overview steps of the method for treating a liquid food according to the present invention.

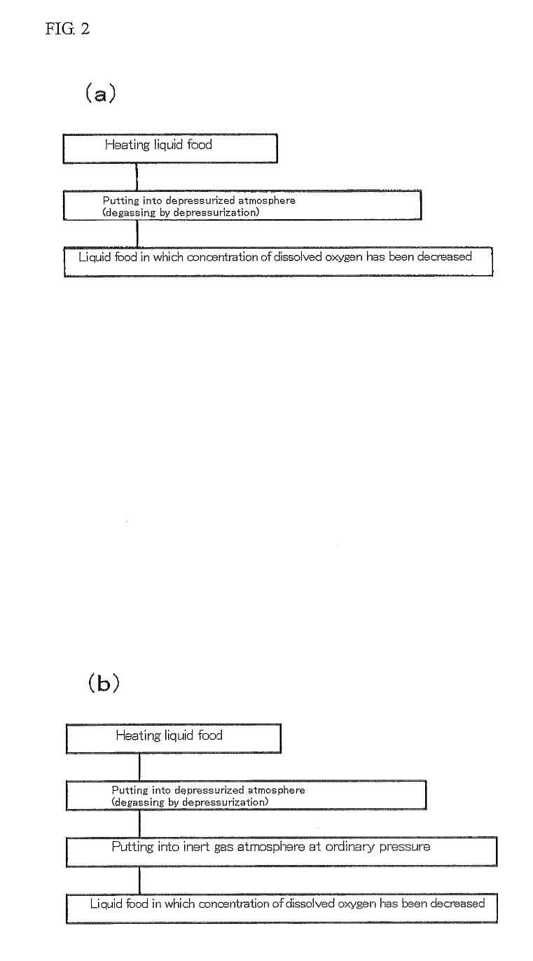

FIGS. 3(a) and (b) show flow charts for explaining the overview steps of the preparation of a powdered food using the method for treating a liquid food according to the present invention.

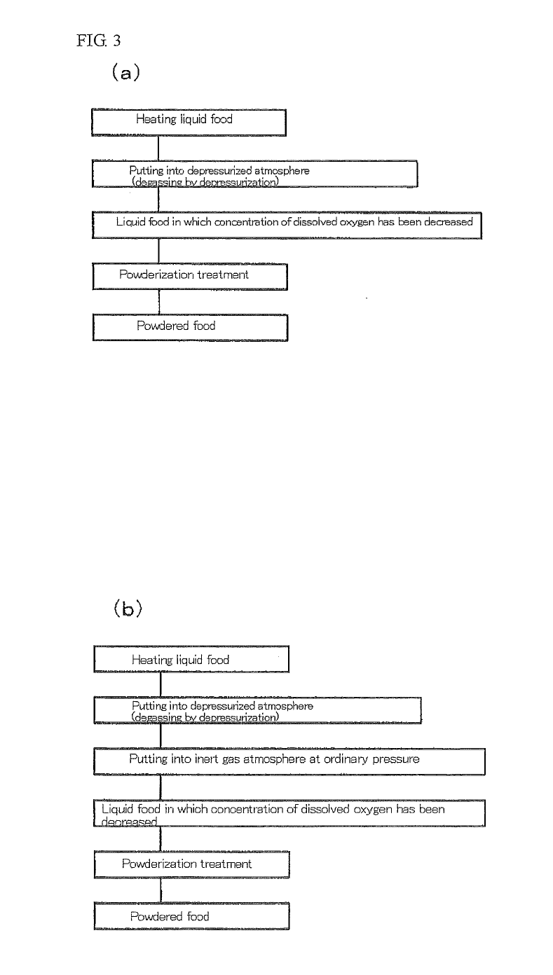

FIGS. 4(a) and (b) show flow charts for explaining the overview steps of the preparation of powdered skim milk using the method for treating a liquid food according to the present invention.

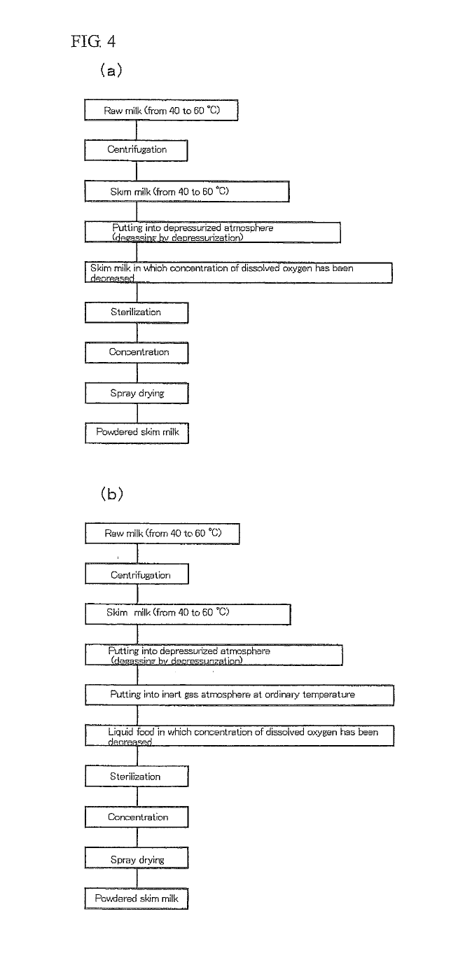

FIG. 5 shows a graph that shows the relationship between the concentration of the dissolved oxygen in the treatment liquid and the temperature of the treatment liquid supplied during the step for degassing by depressurization in the method for treating a liquid food according to the present invention.

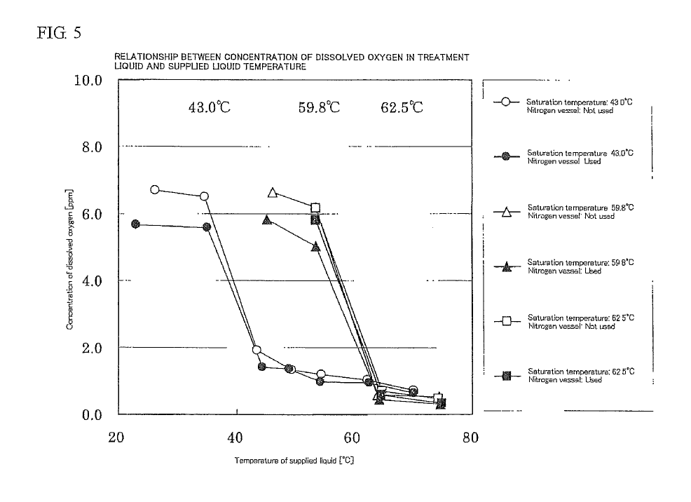

FIG. 6 shows a graph that shows the relationship between the concentration of the dissolved oxygen in the treatment liquid and the saturation pressure of the treatment liquid supplied in the step for degassing by depressurization in the method for treating a liquid food according to the present invention.

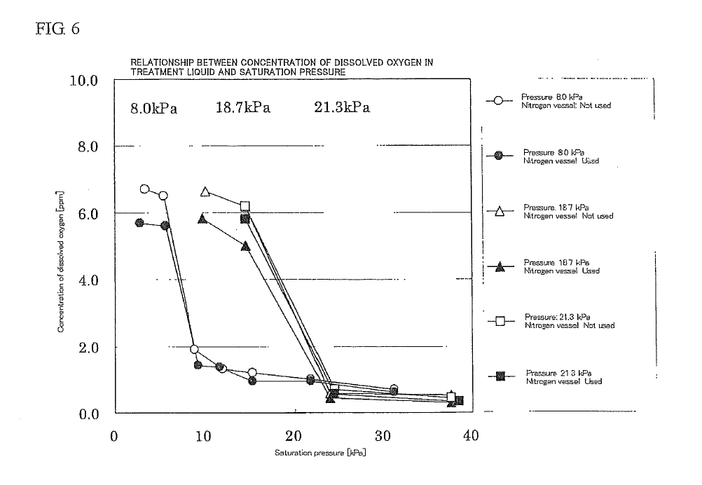

### DESCRIPTION OF REFERENCE NUMERALS

1 Treatment liquid
2 Treatment liquid tank
3 Heat exchanger (for heating)
4 Depressurize tank
5 Inert gas-filled tank

1. A method for treating a liquid food, which decreases a dissolved oxygen concentration of the liquid food by putting the liquid food into a decompression vessel while heating the liquid food to a temperature higher than or equal to saturation temperature of the liquid food under a decompression atmosphere in the decompression vessel.

2. A method for treating a liquid food, which decreases a dissolved oxygen concentration of the liquid food by putting the liquid food into a decompression vessel while depressurizing the decompression vessel to a pressure lower than or equal to a saturation vapor pressure of the liquid food at a temperature of the liquid food.

3. The method for treating a liquid food according to claim 1, wherein the liquid food in which the dissolved oxygen concentration has been decreased in the decompression vessel is further decreased by subsequently putting the liquid food into an inert gas atmosphere at normal pressure.

4. The method for treating a liquid food according to claim 1, wherein the liquid food is skim milk.

5. A method for preparing a powdered food, which comprises powderizing a liquid food in which dissolved oxygen concentration has been decreased by the method according to claim 1.

6. The method for preparing a powdered food according to claim 5, wherein the liquid food is skim milk.

7. A method for preparing powdered skim milk, which comprises centrifuging raw milk at from 40 to 60° C. to give skim milk and subjecting the skim milk to sterilization, concentration and spray drying to give a powdered skim mil, wherein the powdered skim milk is prepared by centrifuging raw milk at from 40 to 60° C. to give skim milk, decreasing dissolved oxygen concentration of the skim milk by continuously using the method for treating a liquid food according to claim 1, and subsequently subjecting the skim milk to the steps of sterilization, concentration and spray drying.
